(19) United States
(12) Patent Application Publication
(10) Pub. No.: US 2026/0309486 A1
(43) Pub. Date: Oct. 8, 2026

(54) MEASURING SMALL ANGLES OF WHEELS OF A STEERED AXLE USING CAMERAS WITH MOTION MAGNIFICATION

(71) Applicant: Torc Robotics, Inc., Blacksburg, VA (US)

(72) Inventors: Chandramouli Gnanasambandham, Weil der Stadt (DE); Simon Baeuerle, Kassel (DE)

(21) Appl. No.: 19/169,868

(22) Filed: Apr. 3, 2025

(51) Int. Cl. G01B 11/26

(52) U.S. Cl. CPC G01B 11/26; G01B 2210/14; G01B 2210/20

(57) ABSTRACT

An autonomy computing system for an autonomous vehicle is disclosed. The autonomy computing system includes at least one memory configured to store machine executable instructions, and at least one processor coupled to the at least one memory and configured to execute the machine executable instructions to configure the at least one processor to: receive sensor data including video data from at least one image sensor; process the sensor data to generate motion magnified sensor data; process the motion magnified sensor data to generate an angle of steered wheels of the autonomous vehicle; and supply the angle as feedback data to a motion controller of the autonomous vehicle to operate the autonomous vehicle within a driving lane.

### TECHNICAL FIELD

The field of the disclosure relates to autonomous vehicles and, more specifically, methods of providing precise on-line feedback of current wheel angles of a steered axle using cameras with motion magnification to improve lateral controller performance.

### BACKGROUND OF THE INVENTION

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data or Global Navigation Satellite Systems (GNSS) data. Behaviors and planning (or behaviors and motion planning (BMP)) technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

A lateral controller adjusts the steering angle based on a steering input such that the autonomous vehicle follows a reference path. For an autonomous vehicle driving on a highway, a steering input to the lateral controller is generally small to keep the autonomous vehicle from wandering off a highway lane. Performance of the lateral controller such as, smoothness, robustness, and precision, is generally directly related to the precision of lateral feedback signals to the lateral controller. The lateral feedback signals include lateral position of the autonomous vehicle relative to the lane in which the autonomous vehicle is currently driving, lateral acceleration, current front wheel angels, etc. A lack of precise lateral feedback signals to the lateral controller can cause the autonomous vehicle to weave or otherwise cause unsafe driving environment for the autonomous vehicle or other nearby vehicles.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, an autonomy computing system for an autonomous vehicle is disclosed. The autonomy computing system includes at least one memory configured to store machine executable instructions, and at least one processor coupled to the at least one memory and configured to execute the machine executable instructions is disclosed. The machine executable instructions configure the at least one processor to receive sensor data including video data from at least one image sensor; process the sensor data to generate motion magnified sensor data; process the motion magnified sensor data to generate an angle of steered wheels of the autonomous vehicle; and supply the angle as feedback data to a motion controller of the autonomous vehicle to operate the autonomous vehicle within a driving lane.

In another aspect, an autonomous vehicle including a plurality of image sensors, at least one memory configured to store machine executable instructions, and at least one processor communicatively coupled with the at least one memory is disclosed. The at least one processor is configured to control lateral movement of the autonomous vehicle by configuring the at least one processor to receive sensor data including video data from at least one image sensor of the plurality of image sensors; process the sensor data to generate motion magnified sensor data; process the motion magnified sensor data to generate an angle of steered wheels of the autonomous vehicle; and supply the angle as feedback data to operate the autonomous vehicle within a driving lane.

In yet another aspect, a computer-implemented method to control lateral movement of an autonomous vehicle is disclosed. The computer-implemented method includes receiving sensor data including video data from at least one image sensor of a plurality of image sensors; processing the sensor data to generate motion magnified sensor data; processing the motion magnified sensor data to generate an angle of steered wheels of the autonomous vehicle; and supplying the angle as feedback data to operate the autonomous vehicle within a driving lane.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1. is a schematic view of an autonomous truck;

FIG. 2 is a block diagram of the autonomous truck shown in FIG. 1;

FIG. 3 is a block diagram of an example computing system;

FIG. 4 illustrates an example processing system for motion magnification; and

FIG. 5 is a flow-chart of an example method of generating feedback for keeping an autonomous truck within its driving lane.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments, and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

One or more of the following terms may be used in the disclosure, and their definition is provided below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Mission control: Mission control, as described in the present disclosure, refers to one or more application servers, and one or more database servers communicatively coupled with each other and one or more autonomous vehicles of a fleet. Mission control receives sensor data collected by one or more sensors of the one or more autonomous vehicles of the fleet and transmit data including, but not limited to, trajectory data, described herein, to the one or more autonomous vehicles of the fleet.

Motion magnification: Motion magnification is a technique that amplifies small, subtle motions in videos to make them detectable.

Imprecise lateral feedback signals to a lateral controller can cause an autonomous vehicle to weave and potentially cause unsafe driving environment for the autonomous vehicle or other nearby vehicles. More precise feedback signals to the lateral controller makes improves the autonomous vehicle's ability to stay within the lane in which the autonomous vehicle is currently driving.

For an autonomous vehicle driving on a highway, i.e., at highway speeds, steering angles of front wheels of the autonomous vehicle are generally small. Measuring the small steering angles with high precision, for example, 0.01 degrees at the front wheels, is difficult with conventional sensors such as, hall-effect rotary encoders, which can impact the lateral controller's performance. Conventional sensors have a resolution, for example, of about 0.1 degrees. However, when precision for feedback to the lateral controller is improved to be about 0.01 degrees using embodiments described herein, lateral controller's performance is significantly improved as the feedback signal to the lateral controller is now based on at least 10 times smaller lateral movements, which prevents or reduces weaving of the autonomous vehicle substantially.

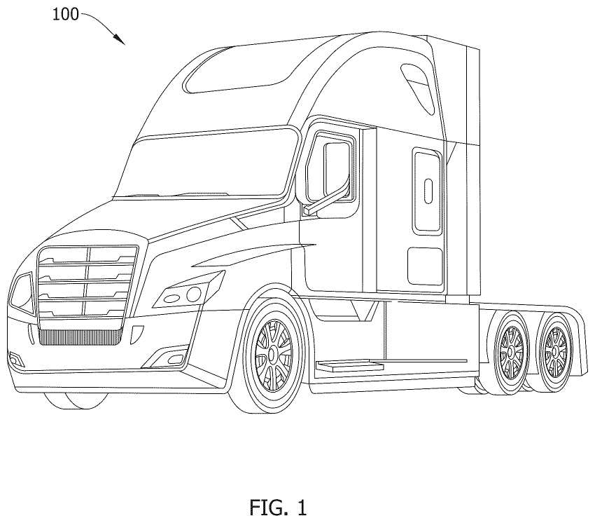

FIG. 1 illustrates a vehicle 100, such as a truck that may be conventionally connected to a single or tandem trailer to transport the trailer (not shown in FIG. 1) to a desired location. The vehicle 100 includes a cabin that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin.

The vehicle 100 may be an autonomous vehicle, in which case the vehicle 100 may omit the steering wheel and the steering column to steer the vehicle 100. Rather, the vehicle 100 may be operated by an autonomy computing system (not shown in FIG. 1) of the vehicle 100 based on data collected by a sensor network (not shown in FIG. 1) including one or more sensors. The vehicle 100 may be an ego vehicle referenced herein.

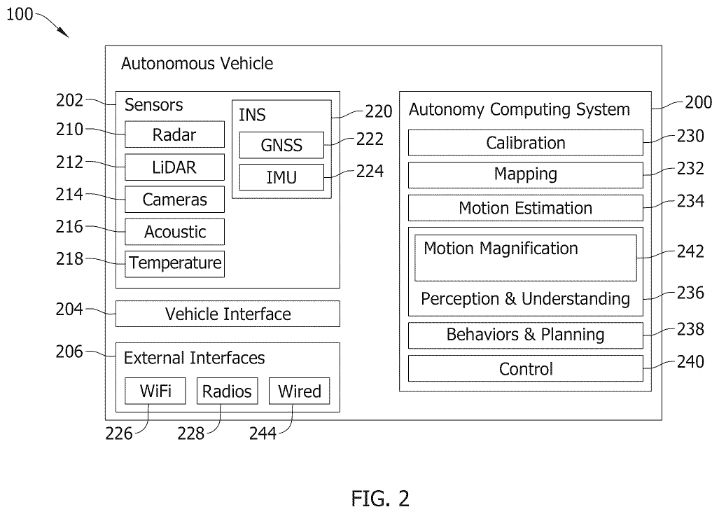

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, and navigation sensors. Navigation sensors, as described herein, may be one or more inertial navigation system (INS) sensors (or systems) 220, one or more global navigation satellite system (GNSS) sensors 222, or one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers or other objects in the environment surrounding autonomous vehicle 100. In some embodiments, the image data generated by cameras 214 may be sent to autonomy computing system 200 or other aspects of autonomous vehicle 100 or mission control (a hub) or both.

Cameras 214 may have temperature sensors 218 (e.g., one or more of negative temperature coefficient (NTC) thermistors, resistance temperature detectors (RTDs), thermocouples, or semiconductor-based integrated (IC) sensors) positioned on an external surface, or an internal surface, or both, to measure temperature on a camera lens surface of each of cameras 214. Additionally, temperature sensors 218 may be positioned on other areas of the autonomous vehicle 100, e.g., to measure ambient temperature.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment. Additionally, or alternatively, GNSS receiver 222 may be configured to receive RTK and GNSS position information from satellite-based systems.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and motion magnification module 242. The motion magnification module 242, for example, may be embodied within another module, such as perception and understanding module 236, behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100. The motion magnification module 242 is configured to amplify small, subtle motions in video or image data of one or more camera sensors of the autonomous vehicle.

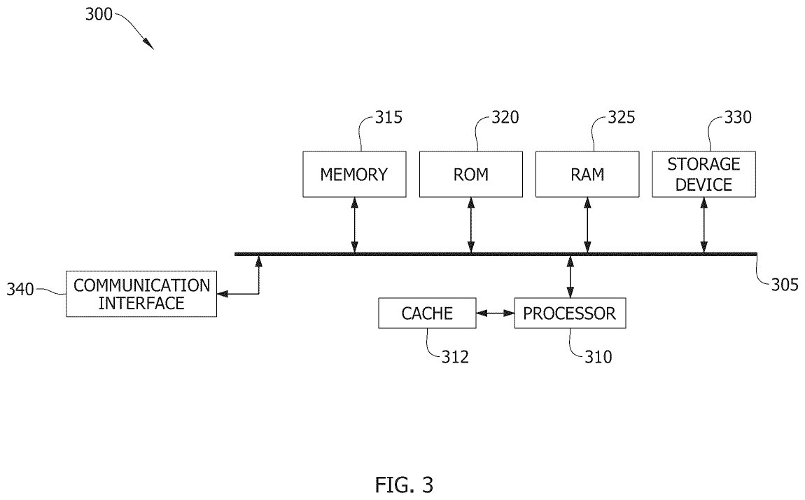

FIG. 3 illustrates an example computing system 300 that can implement various techniques, processes, functions, or methods described herein. Computing system 300 may be embodied within, for example, autonomous vehicle 100 shown in FIG. 1, such as autonomy computing system 200 shown in FIG. 2. The components of computing system 300 are shown in electrical communication with each other using a connection 305, such as a bus. The example computing system 300 includes a processing unit (CPU or processor) 310 and a computing device connection 305 that couples various computing device components, including computing device memory 315, such as a read only memory (ROM) 320 and a random-access memory (RAM) 325, to processor 310.

The processor 310 may be communicatively coupled with a communication interface 340 to communicate with external entities such as, mission control, or one or more other vehicles using V2V communication. Accordingly, the communication interface 340 may include one or more of a radio interface, an electronic sign board mounted on autonomous vehicle 100, a public address system or a loudspeaker positioned at autonomous vehicle 100. The radio interface may be configured for at least one of: (i) a vehicle-to-vehicle communication technique, (ii) citizens band radio frequencies; (iii) a Bluetooth signal; and (iv) a short message service (SMS) technology.

Computing system 300 can include a cache 312 of high-speed memory connected directly with, in close proximity to, or integrated as part of processor 310. Computing system 300 can copy data from memory 315 and/or storage device 330 to cache 312 for quick access by processor 310. In this way, cache 312 can provide a performance boost that avoids processor 310 delays while waiting for data. These and other modules can control or be configured to control processor 310 to perform various actions. Other computing device memory 315 may be available for use as well. Memory 315 can include multiple different types of memory with different performance characteristics. Processor 310 can include any general-purpose processor, central processing unit (CPU), or graphics processing unit (GPU) in combination with a hardware or software provision configured to control processor 310 and stored in storage device 330, as well as any special-purpose processor where software instructions are incorporated into the processor design. Processor 310 may be a self-contained system, containing multiple cores or processors, a bus, memory controller, cache, etc. A multi-core processor may be symmetric or asymmetric.

Storage device 330 is a non-volatile memory and can be one or more of a hard disk or other types of computer readable media that can store data that are accessible by a computer, such as a magnetic cassette, flash memory card, solid state memory device, digital versatile disk, cartridge, RAM 325, ROM 320, or hybrids thereof. Memory 315 or storage device 330 can include software, code, firmware, etc., for controlling processor 310. Other hardware or software modules are contemplated. Memory 315 and storage device 330 are connected to computing device connection 305. In one aspect, a hardware module that performs a particular function can include the software component stored in a computer-readable medium in connection with the necessary hardware components, such as processor 310, computing device connection 305, and so forth, to carry out the function. In the example embodiment, processor 310 may be programmed by encoding an operation or function using one or more executable instructions and providing the executable instructions in memory 315 or storage device 330.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

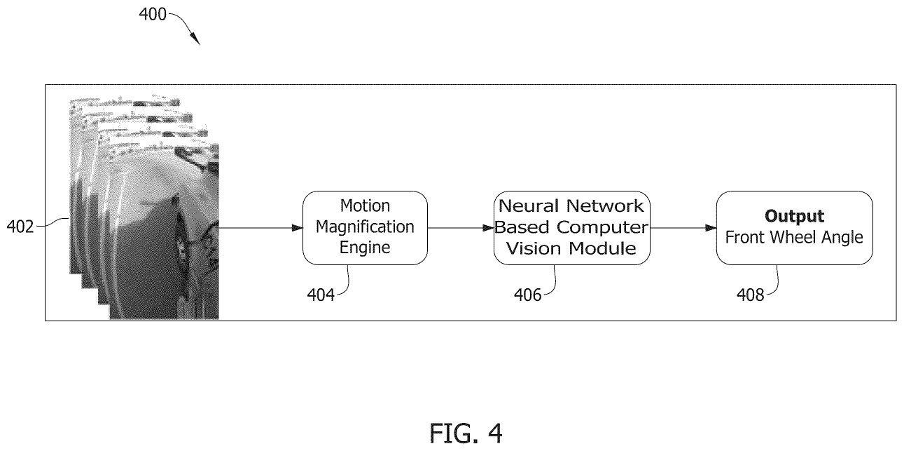

FIG. 4 illustrates an example processing system 400 for motion magnification. Processing system 400 amplifies a video feed or video data 402 of camera sensors (for example, camera sensors 214 shown in FIG. 2) mounted on the autonomous vehicle, such as, for example, autonomous vehicle 100 shown in FIGS. 1 and 2. The processing system 400 can embody, for example, motion magnification module 242 shown in FIG. 2. Referring to FIGS. 1 and 2, for example, the camera sensors 214 are aimed at the wheels of the autonomous vehicle 100. The camera sensors 214 may be mounted, for example, on sideview mirrors. Additionally, or alternatively, the camera sensors 214 may be mounted on a rear side of the tractor or cabin of the autonomous vehicle and aimed at other wheels of a trailer attached with the tractor or cabin of the autonomous vehicle 100. In certain embodiments, the video data 402 may be substituted for multiple images collected by camera sensors 214 at a high frequency, or high speed, and each image may be processed by various components or modules of the processing system 400, as described further below.

In some examples, video feed or video data 402 of the camera sensors 214 is magnified by a motion magnification engine 404. The motion magnification engine 404 is based upon a video data (or image data) processing techniques or algorithms such as, Eulerian Video Magnification (EVM), Lagrangian methods, phase-based motion magnification, that amplify subtle, microscopic amounts of motion in video data (or microscopic amounts of differences in subsequent images of the image data) for detecting visualization of vibrations or any other imperceptible movements. The motion magnification engine 404 produces magnified image or video data as an output.

The magnified image or video data from the motion magnification engine 404 is processed by a neural network-based computer vision module 406 to extract details such as small angles of steered wheels. For example, in certain embodiments, computer vision module 406 may be based upon convolution neural network (CNN). Camera sensors 214 may be equipped with night vision capability to collect video data (or multiple images) during different lighting conditions. For example, in certain embodiments, infrared camera sensors, or camera sensors equipped with an additional illumination source such as, a lamp or an infrared lamp, may be used for enhanced prediction quality based on video (or images) collected during poor lighting conditions.

The details extracted by the computer vision module 406 are generated as an output 408 that can be supplied to a controller, such as processor 310 shown in FIG. 3, for further processing using a pseudo code, as described in detail below.
#Step 1:
Capture Images/Frames from Camera
Initialize camera
While True:
   Capture frame from camera
   Store frame in buffer
   If sufficient frames collected: Break
#Step 2: Apply Motion Magnification
Load collected frames
Preprocess frames #(grayscale, resizing, Apply Eulerian Video Magnification (EVM)
Extract magnified frames
#Step 3: Feature Extraction
For each magnified frame:
   Detect keypoints of the steered wheel #(using optical flow, edge detection, etc.)
   Extract motion-related features #(pixel intensity shifts, phase differences. etc.)
#Step 4: Use Neural Network for Angle Prediction
Load pre-trained neural network model
For each processed frame:
   Feed extracted features into neural network
   Predict steering angle
   Store predictions
#Step 5: Output Results
Compute average or filtered angle from predictions
Display/Log predicted steering angles
#Step 6: Optional—Improve Accuracy
Apply temporal filtering #(Kalman filter, moving average, etc.)
Refine notion magnification parameters
Fine tune neural network with more training data
#Step 7: Deployment
Integrate pipeline into real-time system
Optimize for speed and efficiency

As shown in the pseudo code above, the controller initializes camera sensors 214 (shown in FIG. 2) for capturing and storing images or video data in memory (for example, memory shown in FIG. 2 or FIG. 3). The images or video data stored in the memory is then retrieved for performing motion magnification task by the motion magnification engine 404 (shown in FIG. 4). By way of an example, motion magnification task may be performed by applying Eulerian video magnification (EVM) for identifying subtle changes. However, other algorithms or techniques such as, Lagrangian methods, or phase-based motion magnification may also be used. The subtle changes are identified by amplifying colors, motions, or both to identify imperceptible changes.

Subsequent to the motion magnification task, features are extracted from each magnified frame or image. By way of an example, the features are extracted by detecting a plurality of keypoints of one or more steered wheels. The extracted features are motion related features such as, pixel intensity drifts, phase differences, etc. The plurality of keypoints is detected using, for example, optical flow, edge detection, etc.

The extracted features are then processed through the computer vision software/tool (e.g., a neural network) 406 shown in FIG. 4 by loading a pre-trained neural network model. The pre-trained neural model processes the extracted features by processing each of the extracted features to predict a steering angle. Predictions of the steering angle are stored in the memory for generating an output, for example, the output 408 as shown in FIG. 4. The output may include an average angle or a filtered angle from the predictions for displaying or storing in a log file. The output 408 is provided as feedback to the controller such as, processor 310 shown in FIG. 3, for generating lateral control signals to keep the autonomous vehicle within its driving lane.

Additionally, or alternatively, temporal filtering such as, Kalman filtering, may be applied to improve precision of the output. Additionally, or alternatively, any algorithms or techniques, including Kalman filtering, that improve precision of the output by statistically estimating a true state of the image or video and effectively smoothing out noisy data and removing statistical noise may be used to improve precision of the output. In some examples, motion magnification parameters may be refined or tuned, and the neural network may also be fine-tuned using additional training data for optimizing the processing system 400 for speed and efficiency.

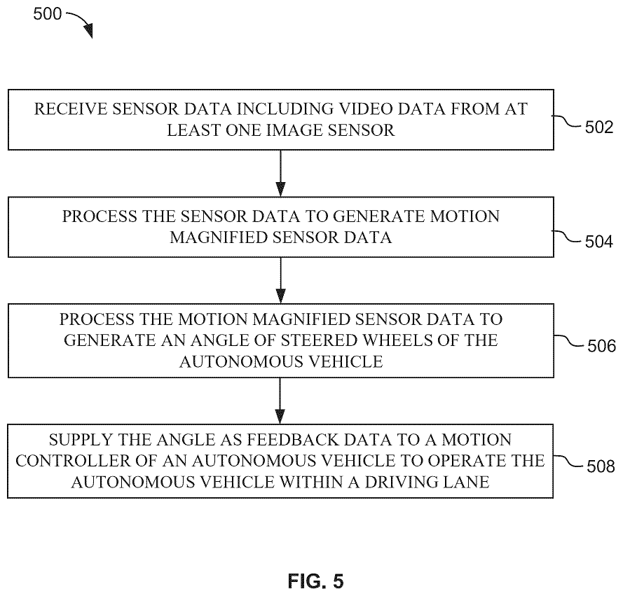

FIG. 5 illustrates a flow-chart of an embodiment method 500 for operating an autonomous vehicle within a driving lane. The method 600 can be embodied within, for example, motion magnification module 242 shown in FIG. 2, which may further be embodied within a computing system such as the computing system 300 shown in FIG. 3. The method includes, at step 502, receiving sensor data. The sensor data includes video data from at least one image sensor of a plurality of image sensors. The at least one image sensor is mounted on the autonomous vehicle to collect the sensor data corresponding to a front-wheel of the autonomous vehicle.

The method includes, at step 504, processing the sensor data to generate motion magnified sensor data. As described herein, the motion magnified sensor data is used for detecting small movements of the front-wheel of the autonomous vehicle. Further, the motion magnified sensor data is generated, for example, using Eulerian video magnification.

The method includes, at step 506, processing the motion magnified sensor data to generate an angle of steered wheels of the autonomous vehicle by detecting a plurality of keypoints from the motion magnified sensor data and extracting a plurality of motion related features from the plurality of keypoints. The plurality of keypoints corresponds with a steered wheel of the steered wheels. And the plurality of motion related features includes at least one of pixel intensity shifts or phase differences. Further, the plurality of keypoints is detected based on at least one of edge detection or optical flow.

The method includes, at step 508, supplying the angle as feedback data to a motion controller of the autonomous vehicle to operate the autonomous vehicle within a driving lane. Additionally, temporal filtering may be applied to improve precision of the angle provided as feedback. By way of an example, temporal filtering may be applied using Kalman filtering.

Accordingly, described embodiments provide measurements of small angles of the steered wheels with high precision without requiring additional or complicated mechanical devices (for example, optical encoders), or computation for suspension kinematics and dynamics. Additionally, wheel angle measurements may be computed by fusing wheel angle measurements for all wheels of the whole truck (tractor and trailer) using sensors like camera sensors, LiDAR sensors, RADAR sensors, or IMU sensors, for enhancing data confidence. Further, performance of lateral controller is improved due to precise feedback based upon measurements of front-wheel steering angles in addition to vehicle state information such as, yaw-rate, velocity, accelerations, etc., and road-surface conditions such as, surface wetness, surface roughness, etc.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, including the implementation or utilization of components of the systems or steps independently and separately from other described components or steps. Therefore, it is manifestly intended that embodiments described herein be limited only by the claims.

What is claimed is:

1. An autonomy computing system for an autonomous vehicle, the autonomy computing
system comprising:
at least one memory configured to store machine executable instructions; and
at least one processor coupled to the at least one memory and configured to execute the machine executable instructions to configure the at least one processor to:
receive sensor data including video data from at least one image sensor;
process the sensor data to generate motion magnified sensor data;
process the motion magnified sensor data to generate an angle of steered wheels of the autonomous vehicle; and
supply the angle as feedback data to a motion controller of the autonomous vehicle to operate the autonomous vehicle within a driving lane.

2. The autonomy computing system of claim 1, wherein the at least one image sensor is mounted on the autonomous vehicle to collect the sensor data corresponding to a front-wheel of the autonomous vehicle.

3. The autonomy computing system of claim 2, wherein the motion magnified sensor data is used for detecting small movements of the front-wheel of the autonomous vehicle, and wherein the motion magnified sensor data is generated using Eulerian video magnification.

4. The autonomy computing system of claim 1, wherein the at least one processor is further configured to execute the machine executable instructions to apply temporal filtering to improve precision of the angle.

5. The autonomy computing system of claim 4, wherein the temporal filtering is applied using Kalman filtering.

6. The autonomy computing system of claim 1, wherein, for processing the motion magnified sensor data, the at least one processor is further configured to execute the machine executable instructions to:
detect a plurality of keypoints from the motion magnified sensor data, wherein the plurality of keypoints corresponds with a steered wheel of the steered wheels; and
extract a plurality of motion related features from the plurality of keypoints.

7. The autonomy computing system of claim 6, wherein the plurality of motion related features includes at least one of pixel intensity shifts or phase differences.

8. The autonomy computing system of claim 6, wherein the plurality of keypoints is detected based on at least one of edge detection or optical flow.

9. An autonomous vehicle, comprising:
a plurality of image sensors;
at least one memory configured to store machine executable instructions; and
at least one processor coupled to the at least one memory and configured to execute the machine executable instructions to control lateral movement of the autonomous vehicle by configuring the at least one processor to:
receive sensor data including video data from at least one image sensor of the plurality of image sensors;
process the sensor data to generate motion magnified sensor data;
process the motion magnified sensor data to generate an angle of steered wheels of the autonomous vehicle; and
supply the angle as feedback data to operate the autonomous vehicle within a driving lane.

10. The autonomous vehicle of claim 9, wherein the at least one image sensor is mounted on the autonomous vehicle to collect the sensor data corresponding to a front-wheel of the autonomous vehicle.

11. The autonomous vehicle of claim 10, wherein the motion magnified sensor data is used for detecting small movements of the front-wheel of the autonomous vehicle, and wherein the motion magnified sensor data is generated using Eulerian video magnification.

12. The autonomous vehicle of claim 10, wherein the at least one processor is further configured to execute the machine executable instructions to apply temporal filtering to improve precision of the angle.

13. The autonomous vehicle of claim 12, wherein the temporal filtering is applied using Kalman filtering.

14. The autonomous vehicle of claim 9, wherein, for processing the motion magnified sensor
data, the at least one processor is further configured to execute the machine executable instructions to:
detect a plurality of keypoints from the motion magnified sensor data, wherein the plurality of keypoints corresponds with a steered wheel of the steered wheels; and
extract a plurality of motion related features from the plurality of keypoints.

15. The autonomous vehicle of claim 14, wherein the plurality of motion related features includes at least one of pixel intensity shifts or phase differences.

16. The autonomous vehicle of claim 14, wherein the plurality of keypoints is detected based on at least one of edge detection or optical flow.

17. A computer-implemented method to control lateral movement of an autonomous vehicle, the computer-implemented method comprising:
receiving sensor data including video data from at least one image sensor of a plurality of image sensors;
processing the sensor data to generate motion magnified sensor data;
processing the motion magnified sensor data to generate an angle of steered wheels of the autonomous vehicle; and
supplying the angle as feedback data to operate the autonomous vehicle within a driving lane.

18. The computer-implemented method of claim 17, wherein the at least one image sensor is mounted on the autonomous vehicle to collect the sensor data corresponding to a front-wheel of the autonomous vehicle, and wherein the motion magnified sensor data is generated using Eulerian video magnification for detecting small movements of the front-wheel of the autonomous vehicle.

19. The computer-implemented method of claim 17, further comprising applying temporal filtering to improve precision of the angle, wherein the temporal filtering is applied using Kalman filtering.

20. The computer-implemented method of claim 17, wherein processing the motion magnified
sensor data comprises:
detecting a plurality of keypoints from the motion magnified sensor data, wherein the plurality of keypoints corresponds with a steered wheel of the steered wheels; and
extracting a plurality of motion related features from the plurality of keypoints,
wherein the plurality of motion related features includes at least one of pixel intensity shifts or phase differences, and
wherein the plurality of keypoints is detected based on at least one of edge detection or optical flow.
